(19) United States
(12) Patent Application Publication
(10) Pub. No.: US 2008/0272213 A1
(43) Pub. Date: Nov. 6, 2008

(54) Spray Gun

(76) Inventor: Chin-Ming Ting, Taichung Hsien (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 11/743,208

(22) Filed: May 2, 2007

(51) Int. Cl. B05B 1/34

(52) U.S. Cl. 239/461

(57) ABSTRACT

A spray gun includes a body, a hole defined thereof, and a nozzle portion. The nozzle portion includes an air-inducting device communicating with the hole, with the air-inducting device including a bore for allowing liquid to flow through and a plurality of retaining sections. Each retaining section includes an elastic element and a detent disposed therein. The nozzle portion also includes a positioning ring having a plurality of engaging portions disposed on an end and an air cap including two horns and a plurality of outlet holes adapted for allowing liquid to flow out. The engaging portions are adapted for receiving the detent. The air cap includes two horns and a plurality of outlet holes adapted for allowing liquid to flow out, with the air cap engaging with the positioning ring.

### BACKGROUND OF THE INVENTION

1. Field of the Invention

The present invention relates to a spray gun, in particular, to a spray gun of which spraying angle can be adjusted.

2. Description of the Related Art

FIG. 13 illustrates a conventional spray gun 94 comprising a head portion 91, horns 92 and a cap 93. The head portion 91 includes a nozzle head 912 with an outlet end 913 which allows liquid to be sprayed from the spray gun 94 to the outside environment. The head portion 91 also has a male thread portion 911 defined on the periphery for attachment to the cap 93. The conventional spray gun 94 can directs air under controlled flow rate and pressure against liquid flowing out of the outlet end 93 so as to achieve a symmetrical and foggy painting effect. Anyway, the spray gun 94 has only one spraying angle and the control of amount of liquid is not enabled.

The present invention is, therefore, intended to obviate or at least alleviate the problems encountered in the prior art.

### SUMMARY OF THE INVENTION

A spray gun includes a body, a hole defined thereof, and a nozzle portion. The nozzle portion includes an air-inducting device communicating with the hole, with the air-inducting device including a bore for allowing liquid to flow through and a plurality of retaining sections. Each retaining section includes an elastic element and a detent disposed therein. The nozzle portion also includes a positioning ring having a plurality of engaging portions disposed on an end and an air cap including two horns and a plurality of outlet holes adapted for allowing liquid to flow out. The engaging portions are adapted for receiving the detent. The air cap includes two horns and a plurality of outlet holes adapted for allowing liquid to flow out, with the air cap engaging with the positioning ring.

It is an objective of the present invention to provide an apparatus which has a simple construction.

It is another objective of the present invention to provide an apparatus of which spraying angle can be quickly changed.

It is another objective of the present invention to provide an apparatus which has three different spraying angles; 0 degree, 45 degrees, and 90 degrees.

Other objectives, advantages, and novel features of the invention will become more apparent from the following detailed description when taken in conjunction with the accompanying drawings.

### BRIEF DESCRIPTION OF THE DRAWINGS

FIG. 1 is a perspective view of a spray gun in accordance with the present invention with a hopper connected thereto.

FIG. 2 is an exploded perspective view of the spray gun of FIG. 1.

FIG. 3 is an enlarged view of an air-inducting device and a positioning ring shown in FIG. 2.

FIG. 4 is a cross-sectional view illustrating the apparatus of the present invention.

FIG. 5 is another cross-sectional view illustrating the apparatus of the present invention.

FIG. 6 is a partial, enlarged, cross-sectional view of FIG. 4.

FIG. 7 is a partial, side view illustrating the liquid is sprayed from the apparatus, with the spraying area bounded by two lines shown in phantom.

FIG. 8 is a different elevation view than FIG. 7.

FIG. 9 is another partial, side view illustrating the liquid is sprayed from the apparatus, with the spraying area bounded by two lines shown in phantom.

FIG. 10 is a different elevation view than FIG. 9.

FIG. 11 is another partial, side view illustrating the liquid is sprayed from the apparatus, with the spraying area bounded by two lines shown in phantom.

FIG. 12 is a different elevation view than FIG. 11.

FIG. 13 is a partial, exploded perspective view of a conventional spray gun.

### DETAILED DESCRIPTION OF THE PREFERRED EMBODIMENT

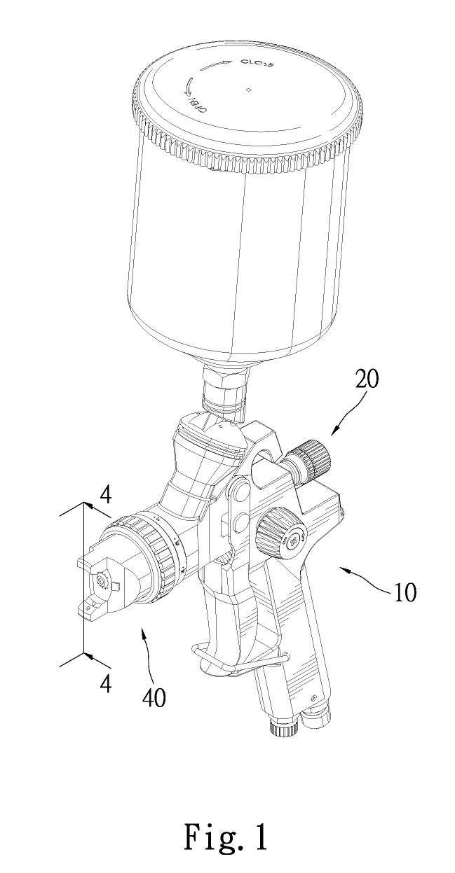

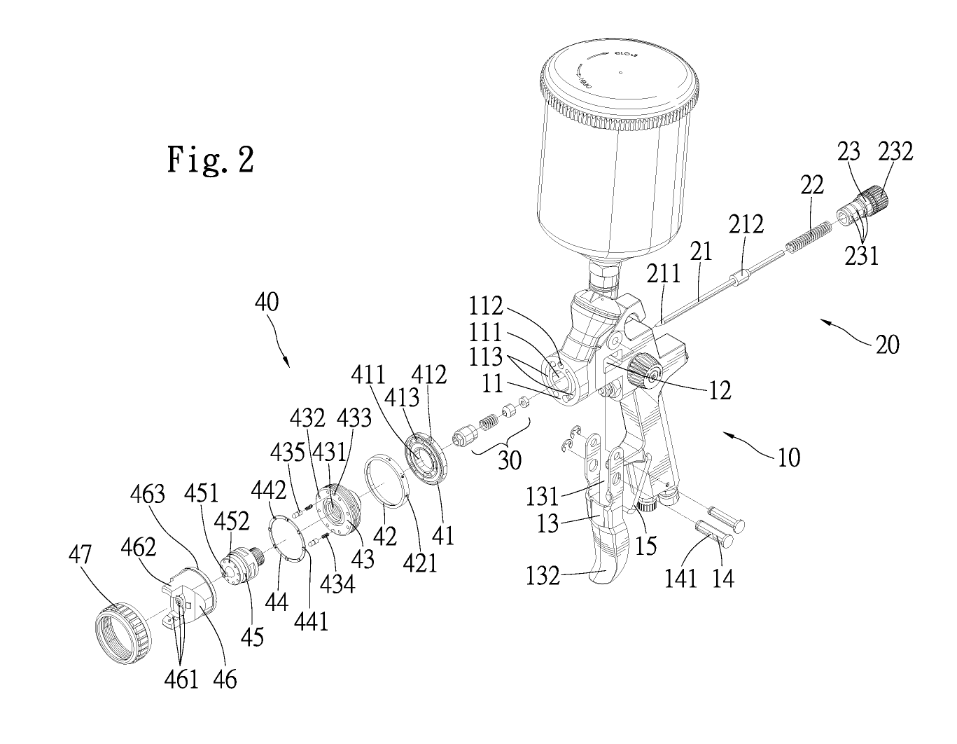

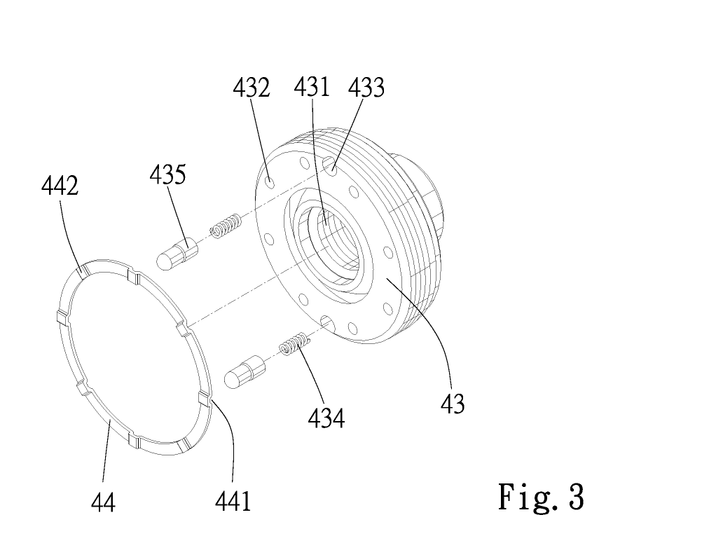

FIGS. 1 through 3 illustrate a spray gun according to the present invention includes a body 10, a control device 20 which is adapted to control the flow rate of liquid, a valve 30, and a nozzle portion 40 which connects to the body 10 and define an interface 11 therebetween. The control device 20 is disposed on one side of the interface 11 while the valve 30 and the nozzle portion are disposed on the opposite side thereof. The body 10 includes a hole 111, a cavity 112 and two air-inlet passages 113 extending from the interface 11 in an axial direction. The cavity 112 is defined above the hole 111. The air-inlet passages 113 are defined around the hole 111. The hole 111 is adapted to provide a passage way for the liquid.

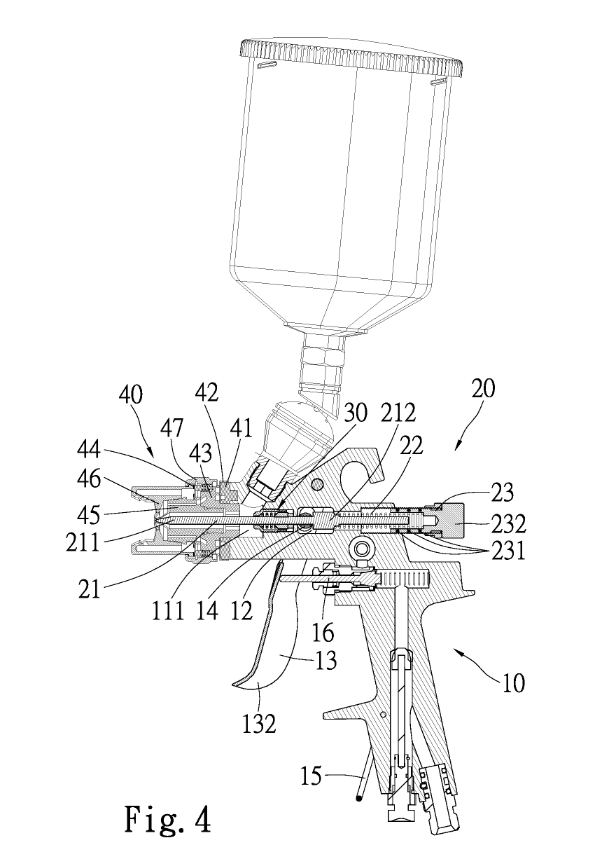

The body 10 also includes a through-hole 12 disposed in a direction perpendicular to the hole 111, with the through-hole 12 intersecting the hole 111 at about the mid-region thereof. The through-hole 12 is adapted to receive a pivotal portion 131 defined on an end of a trigger 13 and a connector 14, wherein the connector 14 is inserted through the pivotal portion 131 of the trigger 13 and the through-hole 12 so as to pivotally connect the trigger 13 to the body 10 and the connector 14 has an aperture 141 disposed at the mid-region thereof for allowing a control device 20 to be inserted therethrough. Furthermore, the trigger 13 also includes a hand-operated portion 132 opposite to the pivotal portion 131, with the hand-operated portion 132 from which the user pulls to spray the liquid, and with the hand-operated portion 132 being pulled by a hook 15 connected to the body 10. In the preferred embodiment of the present invention, the body 10 also includes a rod 16 that automatically urges the trigger 13 to the position as shown in FIG. 4 when the trigger 13 is not pulled by either user's hand or the hook 15.

The control device 20 includes a needle 21 with a pointed end 211 and a stopper 212, an elastic element 22 inserted on the needle 21 and disposed opposite to the pointed end 211, and a control knob 23 which abuts against the elastic element 22. The control knob 23 is threadly engaged with body 10 and serves the purpose to keep the needle 21 and the elastic element 22 within the hole 111 of the body 10. The control knob 23 includes a plurality of indicative regions 231 on one end to show whether the flow rate of the liquid is set at maximum or minimum or intermediate and a rotatable portion 232 on another end to allow the user to operate rotatably. In the preferred embodiment of the present invention, if the indicative region 231 closest to the control knob 23 is set, the flow rate is at maximum. As the indicative region 231 defined is further away from the control knob 23, the flow rate is smaller. Despite that, other alternative orders of the indicative regions 231 are also possible.

The nozzle portion 40 comprises an air-partitioning ring 41, a ring 42 inserted on the air-partition ring 41 having the periphery engraved with 0°, 45° and 90° angle representations 421, an air-inducting device 43, a positioning ring 44 abutting against a side of the air-inducting device 43 having a plurality of engaging portions 441 and fixing portions 442 opposing thereto, an outlet head 45 having a tapered nozzle 451 with a plurality of apertures 452 circumscribing thereof, an air cap 46 having a plurality of outlet holes 461 and two horns 462 disposed at two sides thereof, and a collar 47 inserted on the air cup 46 and threadly engaged with the air-inducting device 43.

The air-partitioning ring 41 includes a bore 411, a protrusion 412 defined above the bore 411, and a plurality of orifice 413 corresponding to the air-inlet passages 113 of the body 10 and surrounding the bore 411. The protrusion 412 is received within the cavity 12 of the body 10.

The air-inducting device 43 includes a bore 431, a plurality of orifice 432 and two retaining sections 433. Each retaining section 433 is adapted for receiving an elastic element 434 and a detent 435. The detent 435 is provided to mesh with an engaging portion 441 of the positioning ring 44. In the preferred embodiment of the present invention, the positioning ring 44 is divided into eight equal sectors by the engaging portions 441 and fixing portions 442. Thus, each sector has a central angle of 45°.

The air cap 46 includes a plurality of fixing portions 463 corresponding to the fixing portions 442 of the positioning ring 44. In the preferred embodiment of the present invention, the fixing portions 442 of the positioning ring 44 are ridged and the fixing portions 463 of the air cap 46 are indented so as to allow an attachment therebetween. The horns 462 are provided to make the shape of the painting elliptic rather than circular.

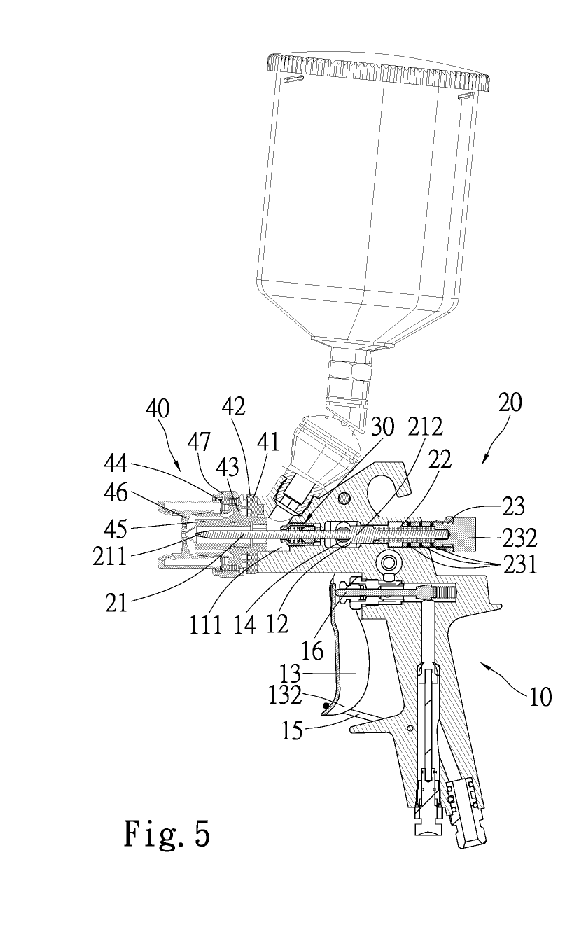

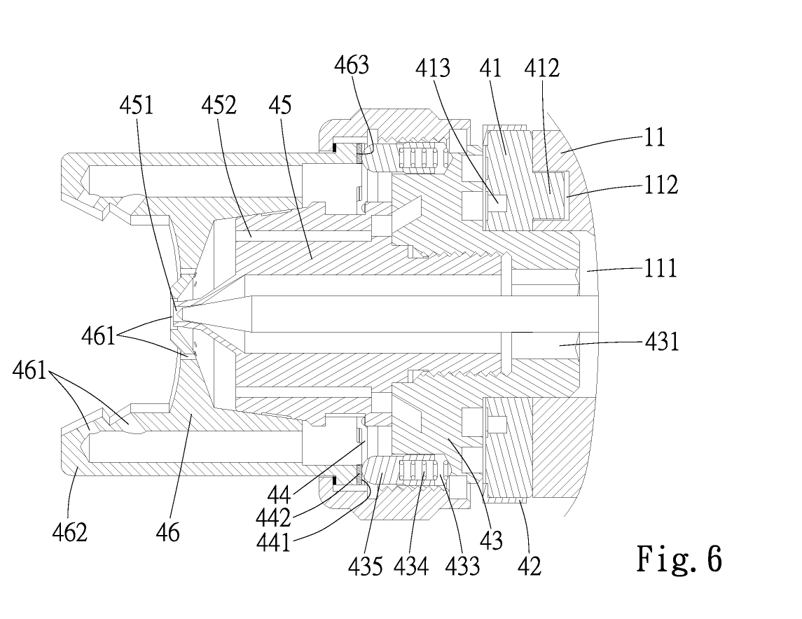

Referring to FIGS. 4 through 6, when the trigger 13 is pulled, the connector 14 is moved from a first position that shuts out the air (as shown in FIG. 4) to a second position that allows the air to enter (as shown in FIG. 5), the control device 20 is compressed by the connector 14, and the needle 21 is moved away from the nozzle 451 of the outlet head 45. Thus, the liquid can flow through the hole 111 and the air can flow through the inlet passage 113. Furthermore, by having each detent 435 incorporated with the engaging portion 441 of the positioning ring 44, the air cap 46 can be easily rotated to a locked position.

Still referring to FIG. 5, the trigger 13 is pulled the by the hook 15. The hook 15 is provided to ease the tiredness after a continuous pulling of the trigger 13. However, if desired, the hook 15 can be disengaged, so that liquid can only be sprayed out of the gun if the trigger 13 is pulled.

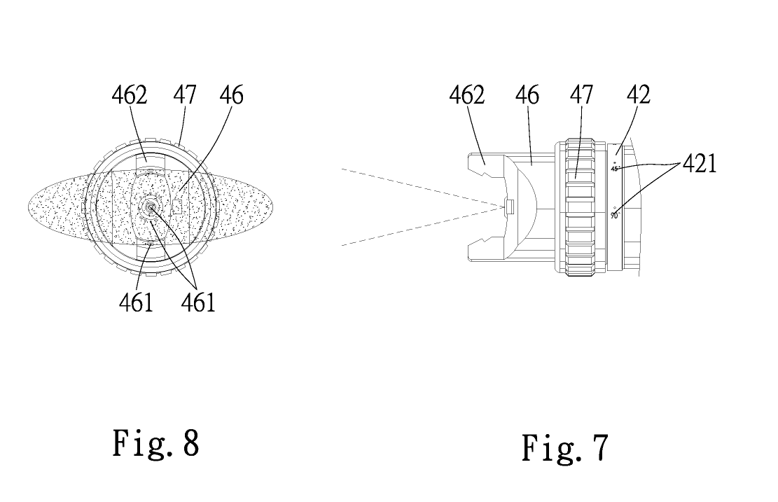

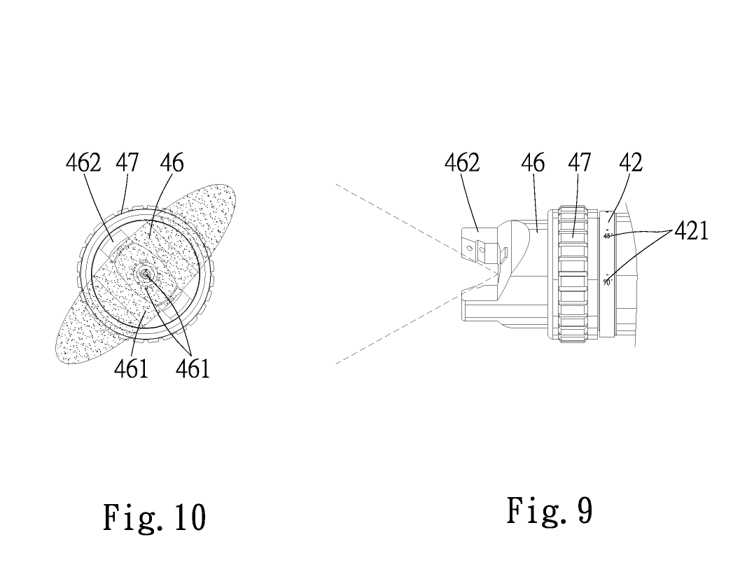

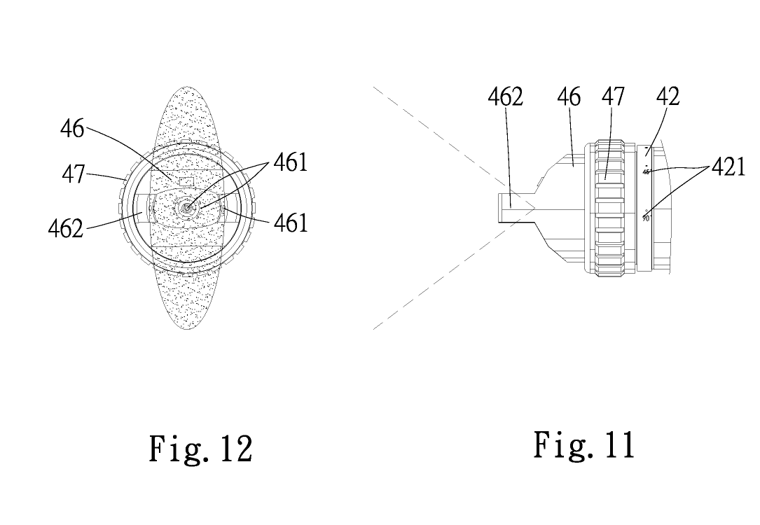

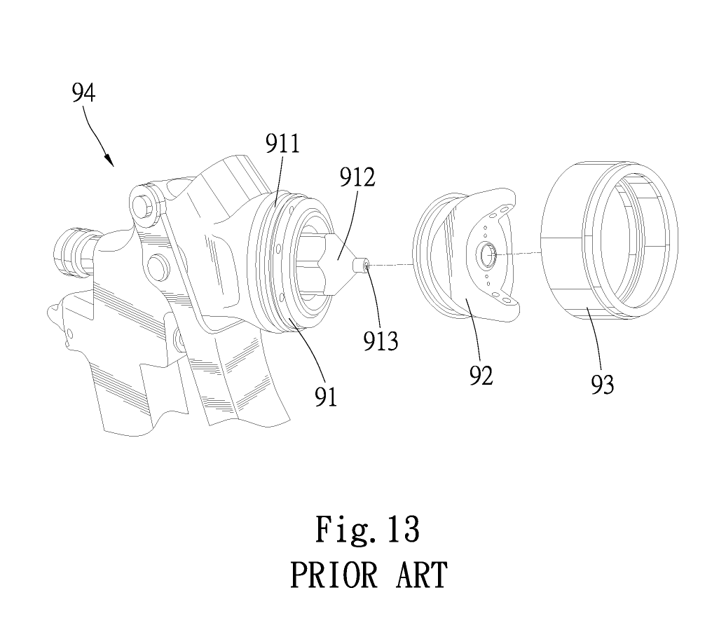

Referring to FIGS. 7 through 12, when the air cap 46 is rotated to make the horns 462 align with angle representation 0°, the liquid is sprayed horizontally as depicted in FIG. 8, when the air cap 46 is rotated to make the horns 462 align with angle representation 45°, the liquid is sprayed as depicted in FIG. 10, and the ellipse is tilted 45 degrees with respect to that of FIG. 8. When the air cap 46 is rotated to make the horns 462 align with angle representation 90°, the liquid is sprayed as depicted in FIG. 12, and the ellipse is tilted 90 degrees with respect to that of FIG. 8.

From the aforementioned description of the spray gun in accordance with the present invention, it is realized that the air-inducting device 43 is securely connected to the body 10, the air-inducting device 43 has detents 435 mounted thereto, and the positioning ring 44 is securely connected to the air cap 46. Furthermore, the positioning ring 44 has engaging portions 441 formed thereof, and the positioning ring 44 can be easily rotated and become interlocked with the detents 435. The liquid can be sprayed horizontally, or in a with a 45 degrees inclination, or with a 90 degrees inclination.

In view of the foregoing, the spray gun has for its objects to provide simple construction, and the spraying angle can be quickly changed. Furthermore, the spray gun has three different spraying angles; 0 degree, 45 degrees, and 90 degrees.

While the specific embodiments have been illustrated and described, numerous modifications come to mind without significantly departing from the spirit of invention and the scope of invention is only limited by the scope of accompanying claims.

What is claimed is:

1. A spray gun of which spraying angle can be adjusted comprising:
a body including a hole defined thereof and a nozzle portion;
with the nozzle portion comprising:
an air-inducting device communicating with said hole, with the air-inducting device including a bore for allowing liquid to flow through and a plurality of retaining sections, with each of said retaining section including an elastic element and a detent disposed therein;
a positioning ring including a plurality of engaging portions disposed on an end, with the engaging portion being adapted for receiving the detent;
an air cap including two horns and a plurality of outlet holes adapted for allowing liquid to flow out, with the air cap engaging with the positioning ring and;
wherein the air cap can be easily rotated to adjust the spraying angle.

2. The spray gun as claimed in claim 1 wherein the body and the air-inducting device include an air-partitioning ring disposed therebetween.

3. The spray gun as claimed in claim 2 wherein the air-portioning ring includes a ring inserted thereon.

4. The spray gun as claimed in claim 3 wherein the ring includes 0°, 45°and 90° angle representations.

5. The spray gun as claimed in claim 1 wherein the positioning ring is divided into eight equal sectors by the engaging portions, with each sector has a central angle of 45 degrees.

6. The spray gun as claimed in claim 1 wherein positioning ring and the air cap includes an outlet head disposed therebetween.

7. The spray gun as claimed in claim 1 wherein the positioning ring includes a plurality of fixing portions opposite to the engaging portions, the air cap includes a plurality of fixing portions, with the fixing portions of the air cap being attached to the fixing portions of the positioning ring.

8. The spray gun as claimed in claim 7 wherein the fixing portions of the positioning ring are ridged.

9. The spray gun as claimed in claim 7 wherein the fixing portions of the air cap are indented.

10. The spray gun as claimed in claim 1 wherein the air cap includes a collar inserted thereon, the collar is threadly engaged with the air-inducing device.

11. The spray gun as claimed in claim 1 wherein the body includes a through-hole disposed in a direction perpendicular to the hole, with the through-hole intersecting the hole at about the mid-region thereof, the body also includes a trigger being received within the through-hole, the trigger is pivotally connected to the body.

12. The spray gun as claimed in claim 11 wherein the through-hole and the trigger include a connector inserting therethrough.

13. The spray gun as claimed in claim 12 wherein the hole includes a control device being received therein, with the control device being disposed opposite to the nozzle portion, and with the control device inserting through the connector.

14. The spray gun as claimed in claim 13 wherein the control device includes a needle, an elastic element and a control knob.

15. The spray gun as claimed in claim 13 wherein the control device and the nozzle portion includes a valve disposed therebetween.

16. The spray gun as claimed in claim 11 wherein the body includes a hook, the hook is adapted to pull the trigger.

17. The spray gun as claimed in claim 11 wherein the body includes a rod that automatically urges the trigger away from the body so that the air is not flowing through the spray gun.

18. The spray gun as claimed in claim 14 wherein the control knob includes a plurality of indicative regions.
